(19) United States
(12) Patent Application Publication
(10) Pub. No.: US 2009/0049969 A1
(43) Pub. Date: Feb. 26, 2009

(54) Workpiece-Advancing Device for a Wood Cutting Apparatus

(76) Inventor: Ching-Chi Lin, Taichung Hsien (TW)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 11/942,169

(22) Filed: Nov. 19, 2007

(30) Foreign Application Priority Data
Aug. 20, 2007 (TW) 096130714

(51) Int. Cl. B26D 7/06; B27B 5/29

(52) U.S. Cl. 83/421; 144/242.1

(57) ABSTRACT

A workpiece-advancing device includes: a slider mounted on a worktable; a workpiece-driving unit mounted on the slider and including a pair of driving rollers and a belt trained on the driving rollers and having a portion adapted to abut against a workpiece and movable relative to the slider for driving movement of the workpiece on the worktable; and a positioning mechanism including an urging unit, a supporting arm unit mounted on the slider and passing through a lateral side of the slider, and an abutting unit mounted on the supporting arm unit and urged by the urging unit so as to be adapted to abut against the workpiece and so as to prevent the workpiece from deviating from a predetermined cutting path.

### CROSS-REFERENCE TO RELATED APPLICATION

This application claims priority of Taiwanese application no. 096130714, filed on Aug. 20, 2007.

### BACKGROUND OF THE INVENTION

1. Field of the Invention

The invention relates to a workpiece-advancing device for a wood cutting apparatus, more particularly to a workpiece-advancing device including a slider and a workpiece-driving unit mounted on the slider for driving movement of a workpiece on a worktable.

2. Description of the Related Art

As shown in FIGS. 1 and 2, a conventional wood cutting apparatus includes a worktable 1 for supporting a workpiece 103 thereon, a pair of rails 2 mounted on the worktable 1, a cutting tool 3 mounted on the worktable 1, a fence 4 mounted slidably on the rails 2, a supporting unit 5 mounted on the worktable 1, and a driving unit 9. The supporting unit 5 includes a supporting stand 6 mounted fixedly on the worktable 1 and provided with a rotatable part 61, a horizontal shaft 7 mounted movably to the rotatable part 61, and a vertical arm 8 mounted movably to the horizontal shaft 7 and connected to the driving unit 9. The driving unit 9 includes a housing 901, a motor 902 mounted on the housing 901, and a plurality of pressing rollers 903 driven by the motor 902.

The aforesaid conventional wood cutting apparatus is disadvantageous in that, since the driving unit 9 is relatively heavy and is disposed at one side of the worktable 1, the wood cutting apparatus tends to become unstable, and since the driving unit 9 has a relatively large size, the working space above the worktable 1 is considerably reduced, which results in inconvenience when conducting a wood cutting operation. In addition, length adjustment of the horizontal shaft 7 for different sizes of the workpiece 103 requires simultaneous movement of the driving unit 9, which is relatively inconvenient to conduct due to the weight of the driving unit 9. Moreover, since the supporting stand 6 is fixed to the worktable 1, the breadth that the fence 4 can move for cutting different sizes of the workpieces 103 is limited.

### SUMMARY OF THE INVENTION

Therefore, the object of the present invention is to provide a workpiece-advancing device for cutting a workpiece that can overcome the aforesaid drawbacks of the prior art.

Accordingly, a workpiece-advancing device of the present invention is provided for a wood cutting apparatus including a worktable for supporting a workpiece thereon. The workpiece-advancing device includes: a slider adapted to be mounted above the worktable, slidable relative to the worktable in a first direction, and having a lateral side adapted to be transverse to the worktable; a workpiece-driving unit mounted on the slider and including first and second driving rollers and a belt trained on the first and second driving rollers and having a portion that is disposed adjacent to and that extends along the lateral side of the slider, that is adapted to abut against a lateral side of the workpiece, and that is movable relative to the slider in a second direction transverse to the first direction for driving the workpiece to move in the second direction; and a positioning mechanism including an urging unit, a supporting arm unit mounted on the slider and passing through the lateral side of the slider, and an abutting unit mounted on the supporting arm unit and urged by the urging unit so as to be adapted to abut against the workpiece and so as to prevent the workpiece from deviating from a predetermined cutting path.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional apparatus for wood cutting;

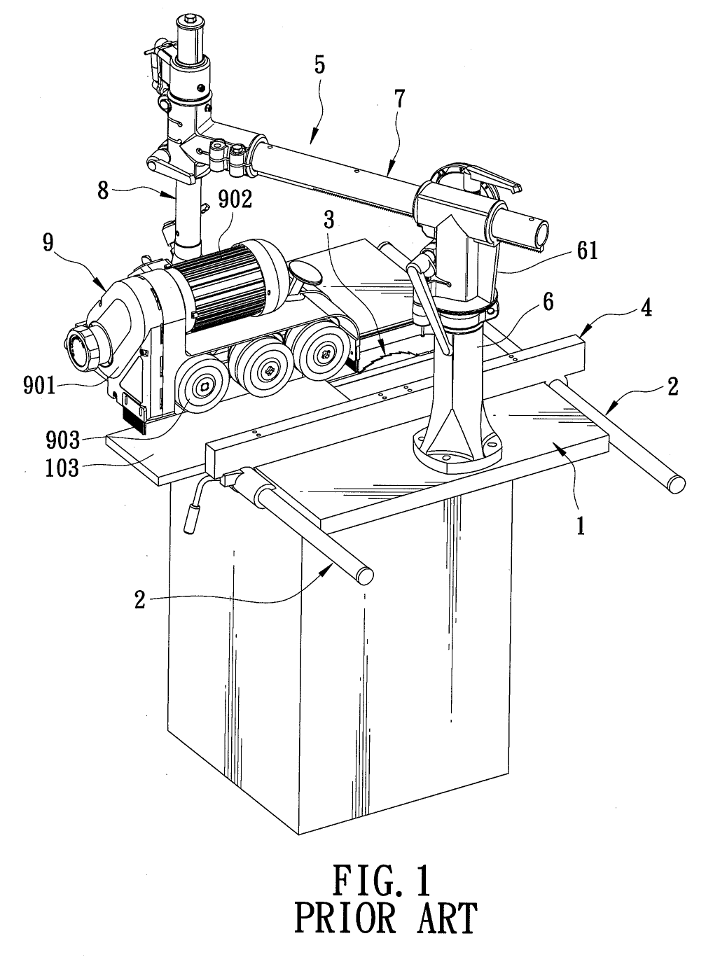

FIG. 2 is a top view of the conventional apparatus;

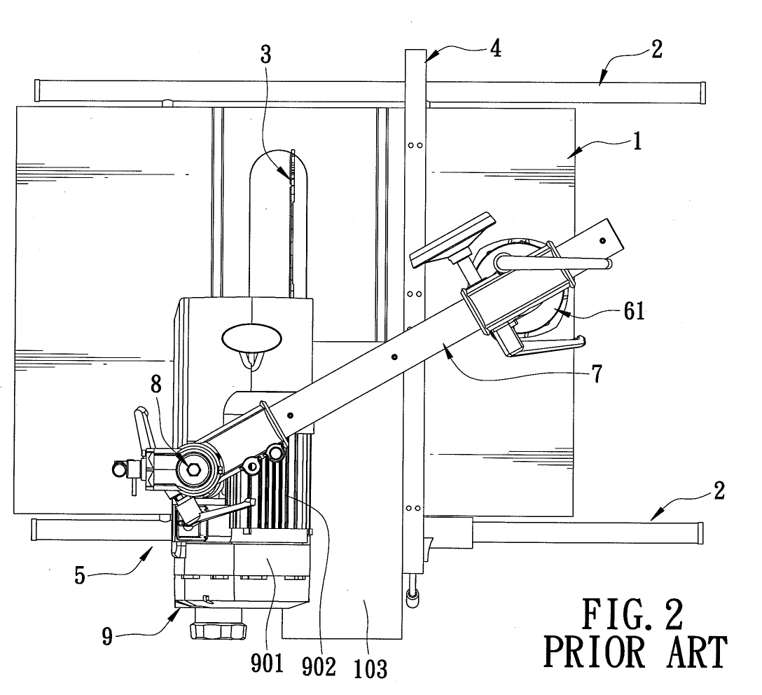

FIG. 3 is an assembled perspective view of the preferred embodiment of an apparatus for cutting a workpiece according to the present invention;

FIG. 4 is a top view of the preferred embodiment;

FIG. 5 is a fragmentary exploded perspective view of a slider of the preferred embodiment;

FIG. 6 is a fragmentary perspective view of the preferred embodiment;

FIG. 7 is a partly sectional view of the preferred embodiment, illustrating the configurations of a positioning mechanism of the preferred embodiment;

FIG. 8 is a fragmentary partly sectional view of the preferred embodiment, illustrating the configuration of a linking mechanism;

FIG. 9 is a fragmentary schematic side view of the preferred embodiment, illustrating how the linking mechanism is operated; and

FIG. 10 is a fragmentary partly sectional view of the preferred embodiment, illustrating how a pressing roller is adjusted in height relative to a worktable.

### DETAILED DESCRIPTION OF THE PREFERRED EMBODIMENT

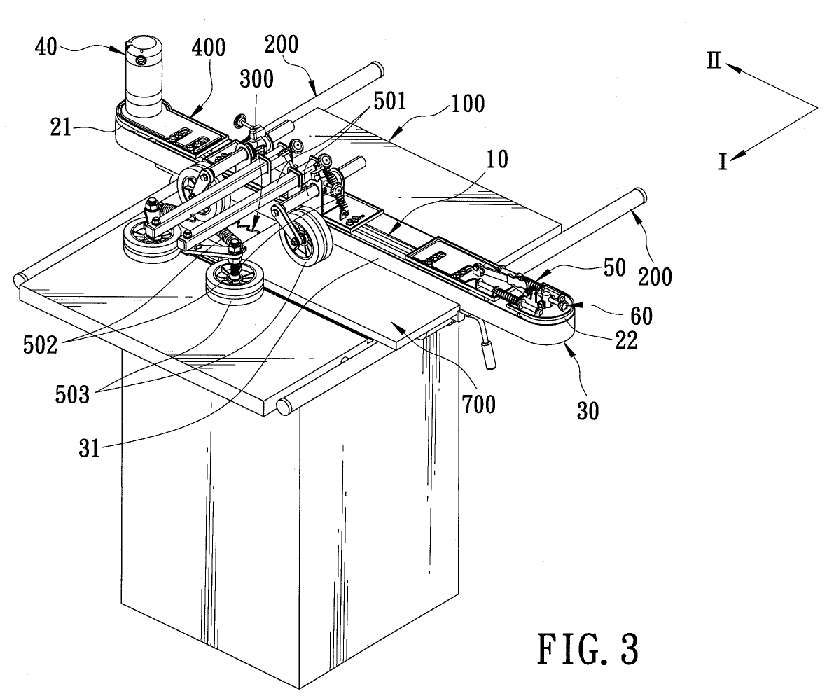

Referring to FIGS. 3 to 6, the preferred embodiment of a wood cutting apparatus for cutting a workpiece 700 according to the present invention includes a base, a worktable 100 mounted securely on the base for supporting the workpiece 700 thereon and provided with a pair of opposite rails 200, and a workpiece-advancing device mounted above the worktable 100.

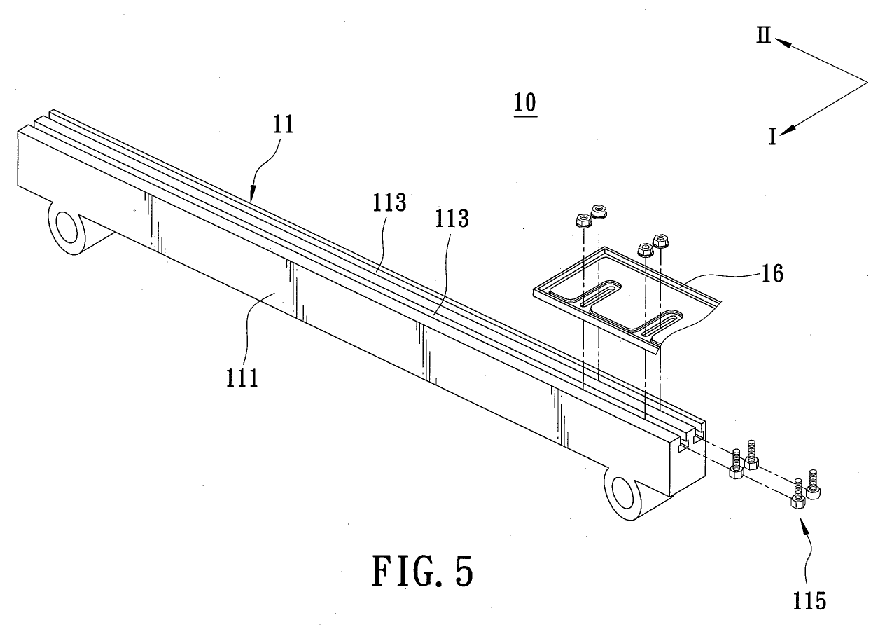

The workpiece-advancing device includes: a slider 10 mounted above the worktable 100 through the rails 200, slidable relative to the worktable 100 in a first direction (I), and having a lateral side 111 (see FIG. 5) transverse to the worktable 100; a workpiece-driving unit 400 mounted on the slider 10 and including first and second driving rollers 21, 22 and a belt 30 trained on the first and second driving rollers 21, 22 and having a portion 31 that is disposed adjacent to and that extends along the lateral side 111 of the slider 10, that is adapted to abut against a lateral side of the workpiece 700, and that is movable relative to the slider 10 in a second direction (II) transverse to the first direction (I) for driving the workpiece 700 to move in the second direction (II); and a positioning mechanism including an urging unit 502 (see FIG. 3), a supporting arm unit 501 mounted on said slider 10 and passing through the lateral side 111 of the slider 10, and an abutting unit 503 mounted on the supporting arm unit 501 and urged by the urging unit 502 so as to be adapted to abut against the workpiece 700 and so as to prevent the workpiece 700 from deviating from a predetermined cutting path. In this embodiment, the urging unit 502 includes a pair of first urging members 75, the supporting arm unit 501 includes a pair of first supporting arms 73 mounted on the slider 10, extending in the first direction (I) and passing through the lateral side 111 of the slider 10, and the abutting unit 503 includes a pair of first pressing rollers 74 mounted respectively on the first supporting arms 73 and urged respectively by the first urging members 75 in the transverse direction toward the worktable 100 so as to be adapted to abut against a top side of the workpiece 700. A cutting tool 300 is mounted on the worktable 100 and lies in the cutting path. The slider 10 is slidable along the rails 200 toward and away from the cutting tool 300.

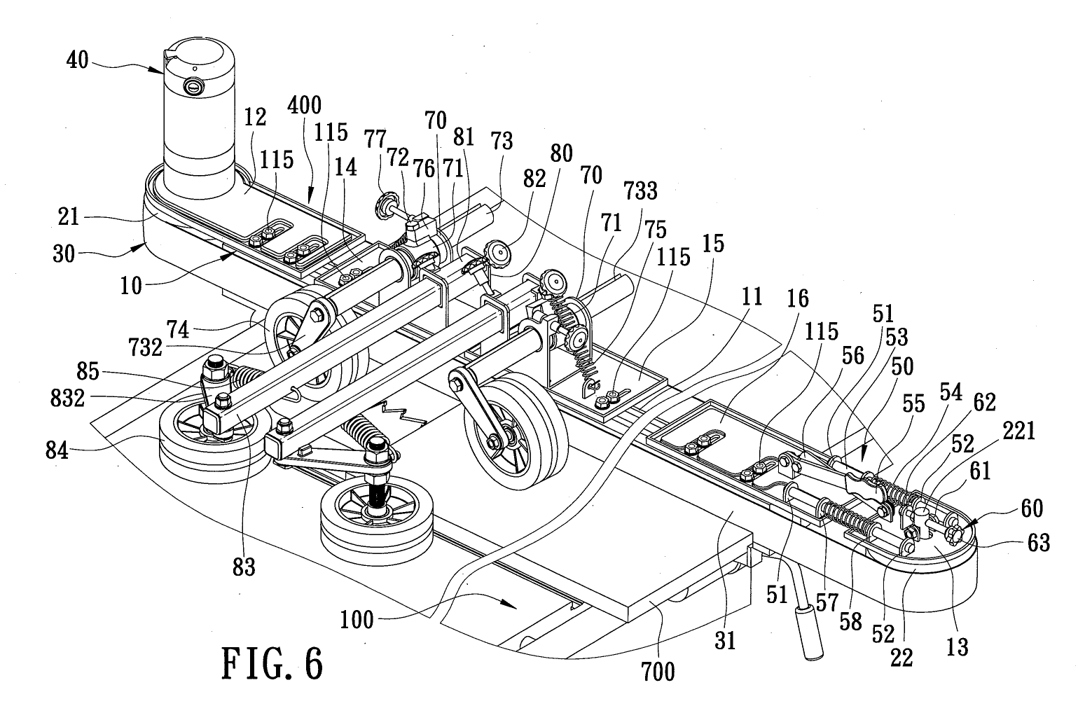

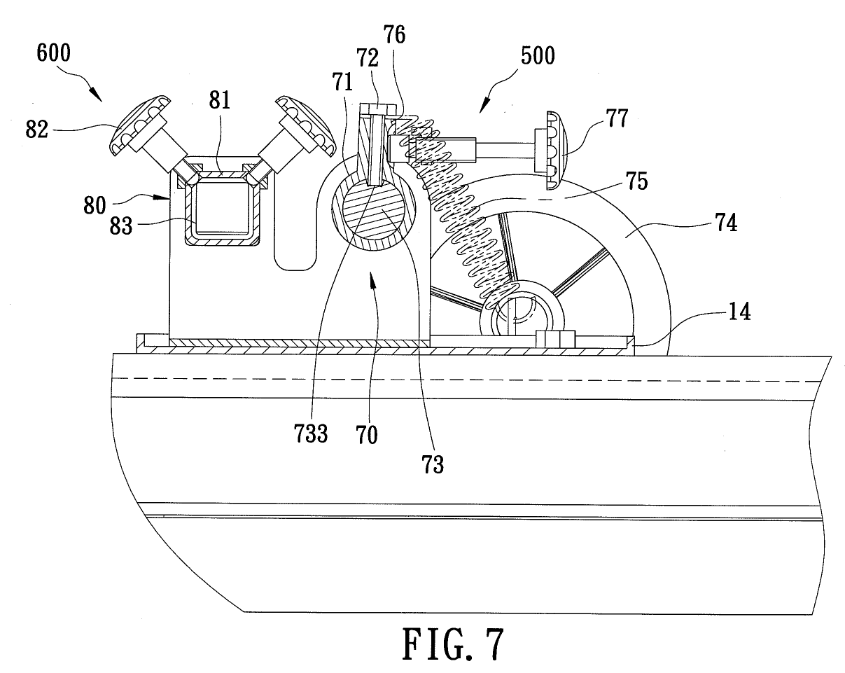

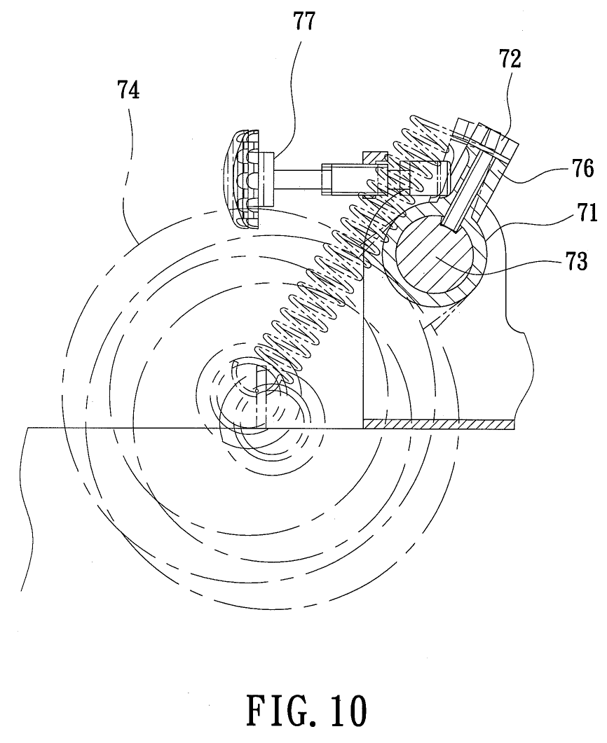

Referring to FIG. 7, in combination with FIG. 6, the positioning mechanism further includes a pair of first arm supports 70 mounted on the slider 10, a pair of first sleeves 71 mounted rotatably and respectively on the first arm supports 70, and a pair of first fasteners 72. Each of the first supporting arms 73 extends coaxially and movably through the respective first sleeve 71, is movable relative to the respective first sleeve 71 in the first direction (I) is formed with a guiding groove 733 extending in the first direction (I), and is provided with a first link 732 at one end thereof. Each first fastener 72 is mounted threadedly on the respective first sleeve 71 and extends into the guiding groove 733 in the respective first supporting arm 73 for securing the respective first supporting arm 73 to the respective first sleeve 71. The first link 732 extends transversely from the end of the first supporting arm 731 to connect with the first pressing roller 74. Each first sleeve 71 is formed with a protrusion 76. Each first fastener 72 extends threadedly through the protrusion 76 and the respective first sleeve 71 and into the guiding groove 733 in the respective first supporting arm 73. The positioning mechanism further includes a pair of screw rods 77, each of which is mounted threadedly on the respective first arm support 70 and having one end abutting against the protrusion 76 for driving rotation of the respective first sleeve 71 relative to the respective first arm support 70 (see FIG. 10) for permitting adjustment of the respective first pressing roller 74 in height relative to the worktable 100 to suit different thicknesses of the workpieces 700.

The positioning mechanism further includes a pair of second arm supports 80 mounted on the slider 10. The supporting arm unit 501 further includes a pair of second supporting arms 83, each of which is mounted on the respective second arm support 80 and each of which is provided with a second link 832 at one end thereof. The urging unit 502 further includes a pair of second urging member 85. The abutting unit 503 further includes a pair of second pressing rollers 84 each of which is connected to the second link 832 and each of which is urged by the respective second urging member 85 in the first direction (I) toward the portion 31 of the belt 30 so as to be adapted to abut against the other lateral side of the workpiece 700.

The positioning mechanism further includes a pair of second sleeves 81 mounted respectively on the second arm supports 80, and a pair of second fasteners 82. Each second supporting arm 83 extends movably through the respective second sleeve 81, is movable relative to the respective second sleeve 81 in the first direction (I), and is provided with a second link 832 at one end thereof. Each second fastener 82 extends threadedly through the respective second sleeve 81, and has one end abutting against the respective second supporting arm 83 so as to secure the respective second supporting arm 83 to the respective second arm support 80. The second link 832 extends from the end of the respective second supporting arm 83 to connect with the respective second pressing roller 84.

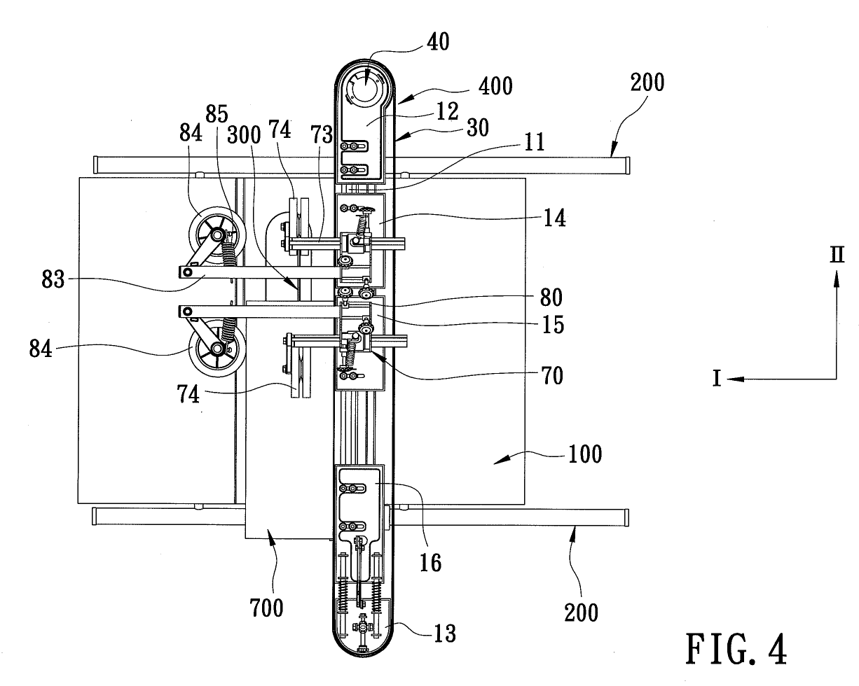

Referring back to FIGS. 5 and 6, the slider 10 includes a crossbar 11 mounted slidably on the worktable 100, defining the lateral side 111 of the slider 10, and formed with a pair of inverted T-shaped grooves 113 extending in the second direction (II), screw means 115 retained in and movable along the T-shaped groove 113, and two first mounting plates 14, mounted on the crossbar 11 through the screw means 115 and aligned in the second direction (II). Each of the first and second arm supports 70, 80 is in the form of a U-shaped plate. Each adjacent pair of the first and second arm supports 70, 80 are an integral part (see FIG. 7), and are raised from a respective one of the first mounting plates 14, 15. Each adjacent pair of the first and second pressing rollers 74, 84 are aligned in the first direction (I) (see FIG. 4). The first pressing rollers 74 are aligned in the second direction (II) (see FIG. 4). The second pressing rollers 84 are aligned in the second direction (II).

The slider 10 further includes a second mounting plate 12 mounted on the crossbar 11 through the screw means 115 and extending outwardly through one end of the crossbar 11. The workpiece-driving unit 400 further includes a motor 40 mounted on the second mounting plate 12, disposed outwardly of the worktable 100, and connected to the first driving roller 21 for driving rotation of the first driving roller 21.

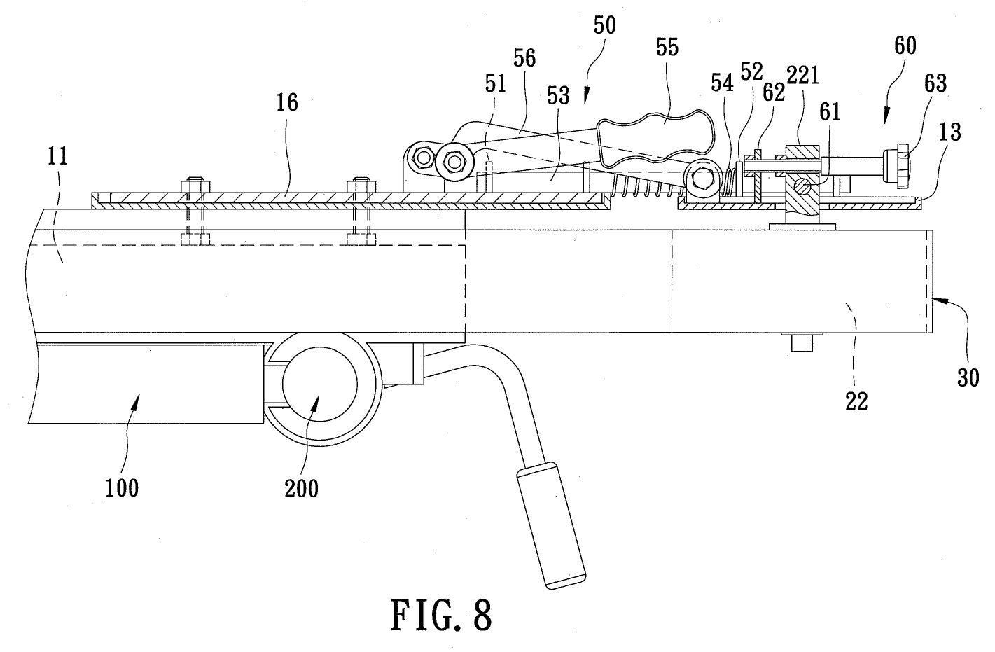

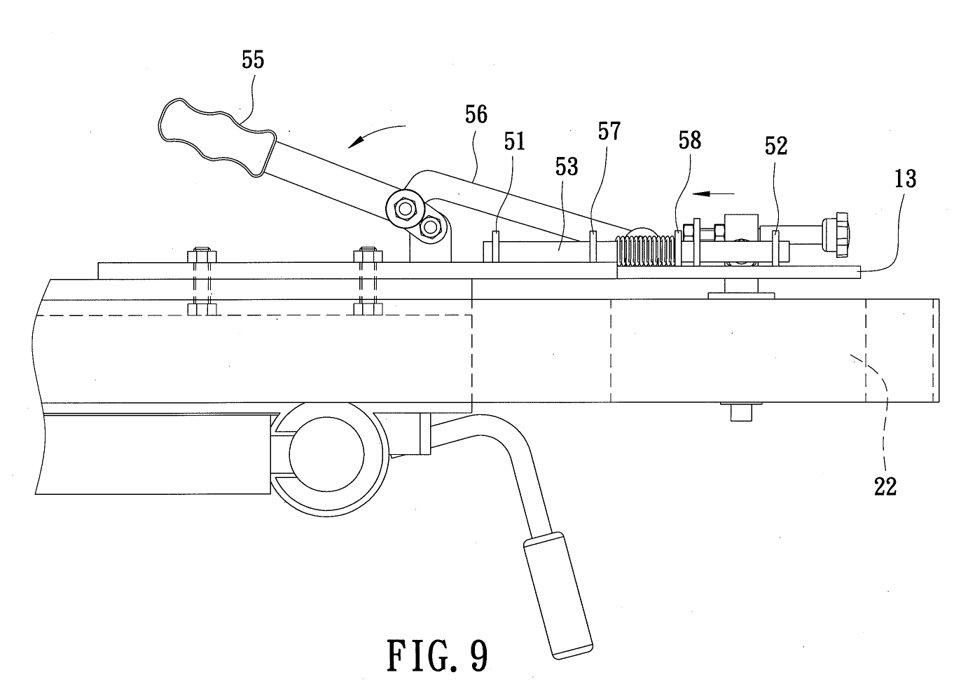

Referring to FIGS. 8 and 9, in combination with FIGS. 5 and 6, the slider 10 further includes a third mounting plate 16 mounted on one end of the crossbar 11 through the screw means 115, a linking mechanism 50, and a fourth mounting plate 13 disposed outwardly of the crossbar 11 and connected adjustably to the third mounting plate 16 through the linking mechanism 50. The second driving roller 22 is mounted on the fourth mounting plate 13. The linking mechanism 50 includes a first linkage 55 pivoted to the third mounting plate 16, and a second linkage 56 having one end pivoted to the fourth mounting plate 13, and an opposite end pivoted to the first linkage 55 so that pivoting movement of the first linkage 55 results in movement of the fourth mounting plate 13 toward and away from the third mounting plate 16, thereby permitting mounting and dismounting of the belt 30 on the first and second driving rollers 21, 22. The linkage mechanism 50 further includes a pair of biasing members 54, a pair of first lugs 51 raised from the third mounting plate 16, a pair of second lugs 57 raised from the third mounting plate 16, a pair of third lugs 58 raised from the fourth mounting plate 13, a pair of fourth lugs 52 raised from the fourth mounting plate 13, and a pair of shafts 53, each of which is fixed to a respective one of the first lugs 51 and extends therefrom through respective ones of the second, third, and fourth lugs 57, 58, 52. Each of the biasing members 54 is sleeved on a respective one of the shafts 53, and is disposed between and abuts against the corresponding second and third lugs 57, 58 for urging the fourth mounting plate 13 to move away from the third mounting plate 16.

Referring again to FIG. 8, the workpiece-advancing device further includes an angle-adjusting unit 60 that has a lug plate 62 fixed to the fourth mounting plate 13, a pivot shaft 61, and an adjusting screw rod 63. The second driving roller 22 has an axle 221 extending through the fourth mounting plate 13 and pivoted to the pivot shaft 61. The adjusting screw rod 63 extends through a hole in the axle 221, which has a size larger than that the cross-section of the adjusting screw rod 63, to engage threadedly the lug plate 62 and a screw nut for preventing rotation of the second driving roller 22 relative to the worktable 100 when the adjusting screw rod 63 is tightened. To adjust the angle of the second driving roller 22 relative to the worktable 100, the adjusting screw rod 63 is required to be loosened from the lug plate 62.

In operation, positions of the first and second pressing rollers 74, 84 are adjusted through adjustment of the first and second supporting arms 73, 83 and the first sleeves 71 so as to permit abutment between the workpiece 700 and the portion 31 of the belt 300, thereby enabling movement of the workpiece 700 in the second direction (II) when the motor 40 is actuated.

With the inclusion of the slider 10 and the workpiece-driving unit 400 in the workpiece-advancing device of the wood cutting apparatus of this invention, the size of the motor 40 for driving the workpiece 700 can be considerably reduced and the aforesaid drawbacks associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A workpiece-advancing device for a wood cutting apparatus including a worktable for supporting a workpiece thereon, said workpiece-advancing device comprising:
a slider adapted to be mounted above the worktable, slidable relative to the worktable in a first direction, and having a lateral side adapted to be transverse to the worktable;
a workpiece-driving unit mounted on said slider and including first and second driving rollers and a belt trained on said first and second driving rollers and having a portion that is disposed adjacent to and that extends along said lateral side of said slider, that is adapted to abut against a lateral side of the workpiece, and that is movable relative to said slider in a second direction transverse to the first direction for driving the workpiece to move in the second direction; and
a positioning mechanism including an urging unit, a supporting arm unit mounted on said slider and passing through said lateral side of said slider, and an abutting unit mounted on said supporting arm unit and urged by said urging unit so as to be adapted to abut against the workpiece and so as to prevent the workpiece from deviating from a predetermined cutting path.

2. The workpiece-advancing device as claimed in claim 1, wherein said abutting unit is urged by said urging unit in the first direction so as to be adapted to abut against the other lateral side of the workpiece.

3. The workpiece-advancing device as claimed in claim 1, wherein said abutting unit is urged by said urging unit in the transverse direction toward the worktable so as to be adapted to abut against a top side of the workpiece.

4. The workpiece-advancing device as claimed in claim 3, wherein said urging unit includes a first urging member, said supporting arm unit including a first supporting arm mounted on said slider and passing through said lateral side of said slider, said abutting unit including a first pressing roller mounted on said supporting arm and urged by said first urging member in the transverse direction relative to the worktable so as to be adapted to abut against the top side of the workpiece.

5. The workpiece-advancing device as claimed in claim 4, wherein said positioning mechanism further includes a first arm support mounted on said slider, a first sleeve mounted rotatably on said first arm support, and a first fastener, said first supporting arm extending coaxially and movably through said first sleeve, being movable relative to said first sleeve in the first direction, being formed with a guiding groove extending in the first direction, and being provided with a first link at one end thereof, said first fastener being mounted threadedly on said first sleeve and extending into said guiding groove for securing said first supporting arm to said first sleeve, said first link extending transversely from said end of said first supporting arm to connect with said first pressing roller.

6. The workpiece-advancing device as claimed in claim 5, wherein said first sleeve is formed with a protrusion, said first fastener extending threadedly through said protrusion and said first sleeve and into said guiding groove in said first supporting arm, said positioning mechanism further including a screw rod mounted threadedly on said first arm support and having one end abutting against said protrusion for driving rotation of said first sleeve relative to said first arm support for permitting adjustment of said first pressing roller in height relative to said worktable.

7. The workpiece-advancing device as claimed in claim 4, wherein said positioning mechanism further includes a second arm support mounted on said slider, said supporting arm unit further including a second supporting arm mounted on said second arm support and provided with a second link at one end thereof, said urging unit further including a second urging member, said abutting unit further including a second pressing roller that is connected to said second link and that is urged by said second urging member in the first direction toward said portion of said belt so as to be adapted to abut against the other lateral side of the workpiece.

8. The workpiece-advancing device as claimed in claim 7, wherein said positioning mechanism further includes a second sleeve mounted on said second arm support, and a second fastener, said second supporting arm extending movably through said second sleeve, and being movable relative to said second sleeve in the first direction, said second fastener extending threadedly through said second sleeve and having one end abutting against said second supporting arm so as to secure said second supporting arm to said second arm support, said second link extending from said end of said second supporting arm to connect with said second pressing roller.

9. The workpiece-advancing device as claimed in claim 7, wherein said slider includes a crossbar adapted to be mounted slidably on the worktable, defining said lateral side of said slider, and formed with an inverted T-shaped groove extending in the second direction, screw means retained in and movable along said T-shaped groove, and a first mounting plate mounted on said crossbar through said screw means, each of said first and second arm supports being raised from said first mounting plate.

10. The workpiece-advancing device as claimed in claim 9, wherein said slider further includes a second mounting plate mounted on said crossbar through said screw means, said workpiece-driving unit further including a motor mounted on said second mounting plate and connected to said first driving roller for driving rotation of said first driving roller.

11. The workpiece-advancing device as claimed in claim 10, wherein said slider further includes a third mounting plate mounted on one end of said crossbar through said screw means, a linking mechanism, and a fourth mounting plate disposed outwardly of said crossbar and connected adjustably to said third mounting plate through said linking mechanism, said second driving roller being mounted on said fourth mounting plate, said linking mechanism including a first linkage pivoted to said third mounting plate, and a second linkage having one end pivoted to said fourth mounting plate, and an opposite end pivoted to said first linkage so that pivoting movement of said first linkage results in movement of said fourth mounting plate toward or away from said third mounting plate, thereby permitting mounting and dismounting of said belt on said first and second driving rollers.

12. The workpiece-advancing device as claimed in claim 11, wherein said linkage mechanism further includes a biasing member, first and second lugs raised from said third mounting plate, third and fourth lugs raised from said fourth mounting plate, and a shaft fixed to said first lug and extending therefrom through said second, third, and fourth lugs, said biasing member being sleeved on said shaft and being disposed between and abutting against said second and third lugs for urging said fourth mounting plate to move away from said third mounting plate.

13. The workpiece-advancing device as claimed in claim 11, further comprising an angle-adjusting unit that has a lug plate fixed to said fourth mounting plate, a pivot shaft, and an adjusting screw rod, said second driving roller having an axle extending through said fourth mounting plate and pivoted to said pivot shaft, said adjusting screw rod extending through said axle to engage threadedly said lug plate.
